(19) United States
(12) Patent Application Publication
(10) Pub. No.: US 2019/0185130 A1
(43) Pub. Date: Jun. 20, 2019

(54) Electrical and Electronic Bay Over Landing Gear Bay

(71) Applicant: Airbus Operations S.A.S., Toulouse (FR)

(72) Inventors: Bernard Guering, Montrabe (FR); Laurent Saint-Marc, Montaigut Sur Save (FR)

(73) Assignee: Airbus Operations S.A.S., Toulouse (FR)

(21) Appl. No.: 16/221,741

(22) Filed: Dec. 17, 2018

(30) Foreign Application Priority Data
Dec. 19, 2017 (FR) 17 62489

(51) Int. Cl. B64C 1/10; B64D 43/00

(52) U.S. Cl. CPC B64C 1/10; B64C 1/068; B64D 43/00

(57) ABSTRACT

An electrical and electronic bay for an aircraft includes a central area forming a free space, a peripheral side area provided for the arrangement of supporting structures and being placed around said central area, and a lower area placed below the central and peripheral side areas and in which the access opening is placed in said central area. Such an electrical and electronic bay is used in particular to optimize the areas dedicated to the incorporation of electronic equipment in aircraft.

### FIELD OF THE INVENTION

The present invention relates to an electrical and electronic bay, and to an aircraft comprising such a bay.

In general, the invention relates to the installation of electronic equipment in the hold of an aircraft.

### BACKGROUND OF THE INVENTION

A certain number of items of aircraft equipment are placed in a space located below the floor of the cockpit and of the passenger cabin. This space is known as the hold of the aircraft.

Aircraft equipment may for example be electronic equipment such as computers.

Electronic equipment is placed within supporting structures or units provided for this purpose, the supporting structures or units being placed in bays provided for housing this equipment in the hold of the aircraft. These bays are known as “electrical and electronic bays” or “EE bays”.

Electrical and electronic bays will be referred to as EE bays in this document.

In general, EE bays are arranged in various free spaces left in the hold of the aircraft by bulky equipment, such as the landing gear. These free spaces are often small since the electronic equipment housed by an EE bay is not very voluminous.

Since the number of items of electronic equipment required in modern aircraft is ever increasing, multiple EE bays have to be provided in an aircraft in order to house the electronic equipment.

EE bays must be accessible for carrying out maintenance on the electronic equipment in the bay. For this purpose, an access or “manhole” to each EE bay is provided so that an operator is able to perform maintenance on the equipment in each bay.

### BRIEF SUMMARY OF THE INVENTION

Aspects of the present invention may provide an electrical and electronic bay of a novel design allowing a large volume of electronic equipment to be accessed simultaneously.

According to a first aspect, the present invention relates to an electrical and electronic bay for an aircraft including at least one supporting structure that is designed to hold electronic equipment and an access opening allowing access to the interior of said bay.

The electrical and electronic bay includes a central area forming a free space, a peripheral side area provided for the arrangement of supporting structures and being placed laterally around the central area, and a lower area placed below the central area and the peripheral side area and in which the access opening is placed in the central area.

By virtue of this arrangement of the electrical and electronic bay, a single opening or manhole allows access to a substantial volume of electronic equipment. Carrying out maintenance on the electronic equipment is thus facilitated and maintenance time is consequently decreased with respect to one and the same volume of electronic equipment housed in multiple EE bays.

Furthermore, because the central area of the bay is empty and placed above the opening, easy access to the electronic equipment arranged in the peripheral side area surrounding the central area is afforded.

According to other possible features, taken individually or in combination with one another:
the lower area of the electrical and electronic bay corresponds to a wall forming the ceiling of a landing gear bay;
the electrical and electronic bay includes an access hatch that is located in the wall forming the ceiling of the landing gear bay, the access hatch being designed to close off the access opening and opening outward in relation to the electrical and electronic bay;
the access hatch is designed to pressurize the electrical and electronic bay;
the electrical and electronic bay includes at least one supporting structure placed in the peripheral side area, said at least one supporting structure including a front face that is located on the side of the central area, the front face allowing electronic equipment to be inserted into the supporting structure and removed from the supporting structure;
the electrical and electronic bay includes a plurality of supporting structures that are arranged in said peripheral side area such that the front faces define said free space of said central area; and
the electrical and electronic bay includes an additional access opening allowing access to the interior of said electrical and electronic bay, the additional access opening being placed above said central area.

According to a second aspect, the present invention also relates to an aircraft comprising at least one electrical and electronic bay according to the invention.

The electrical and electronic bay is placed above a landing gear bay.

Such an aircraft exhibits features and advantages that are analogous to those described above with reference to the electrical and electronic bay.

Other particularities and advantages of the invention will become further apparent from the following description.

### BRIEF DESCRIPTION OF THE DRAWINGS

In the appended drawings, provided by way of nonlimiting examples:

FIG. 1 is a schematic view in perspective of an EE bay according to one embodiment of the invention;

FIG. 2 is a schematic top view of the EE bay according to the exemplary embodiment of FIG. 1;

FIG. 3 is a schematic side sectional view of the nose of the fuselage illustrating the EE bay according to the exemplary embodiment of FIG. 1;

FIG. 4A is a partial schematic longitudinal sectional view of the nose of the fuselage illustrating the EE bay according to the exemplary embodiment of FIG. 1;

FIG. 4B is a partial schematic cross sectional view of the nose of the fuselage illustrating the EE bay according to the exemplary embodiment of FIG. 1; and

FIG. 5 is a schematic view in perspective of an EE bay according to a second embodiment of the invention.

### DETAILED DESCRIPTION

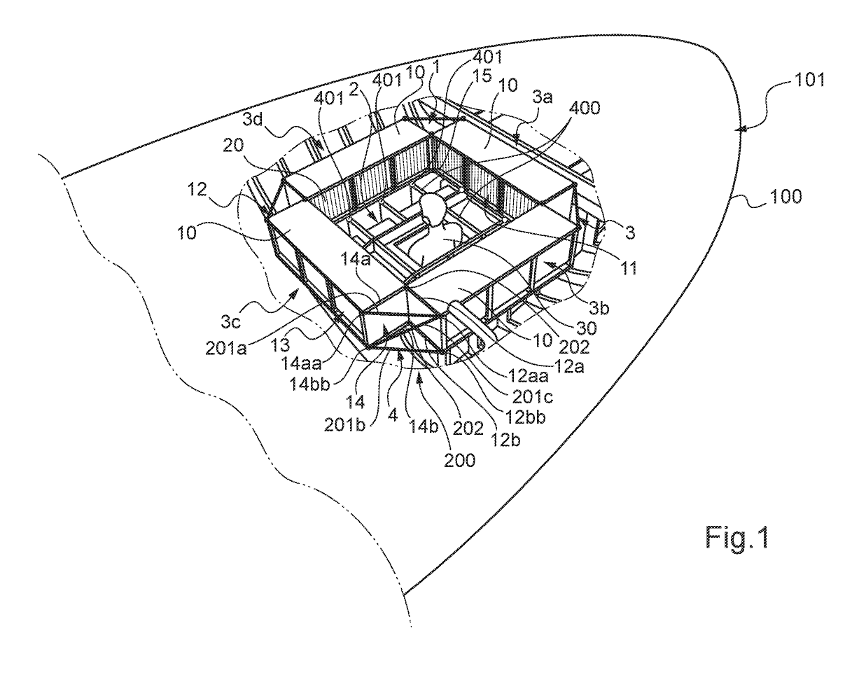

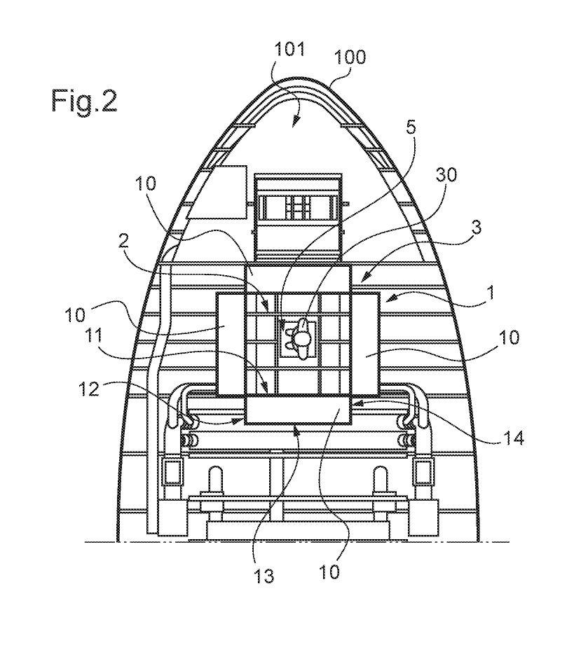

An EE bay according to one embodiment is described below with reference to FIGS. 1 and 2.

The EE bay 1 includes a central area 2 including a free space and a peripheral side area 3 laterally surrounding the central area 2. At least one supporting structure 10 that is designed to hold electronic equipment 20 is arranged in the peripheral side area 3.

In other words, the central area 2 corresponds to the free space in the center of the EE bay 1, the volume of the central area 2 being defined laterally by the peripheral side area 3.

The peripheral side area 3 is defined as a space located around the central area 2 and defining both the central area 2 and the EE bay 1.

The EE bay 1 further includes a lower area 4 placed below the central area 2 and the peripheral side area 3. An access opening 5 (shown in FIG. 2) allowing access to the interior of said EE bay 1 from outside the EE bay 1 is placed in said central area 2 in the lower area 4.

In the described embodiment, the peripheral side area 3 is divided into four peripheral side spaces 3a-3d.

In this embodiment, a supporting structure 10 is placed in each peripheral side space 3a-3d. Thus, in this embodiment, the EE bay 1 includes four supporting structures 10.

In other embodiments (not illustrated), some of the peripheral side spaces 3a-3d are occupied by a supporting structure 10 and some are free. Thus, the number of supporting structures may vary.

In the described embodiment, the supporting structures 10 are identical.

In this embodiment, the four supporting structures 10 are placed in the peripheral side area 3 such that the free space of the central area 2 defined by the supporting structures 10 takes the shape of a square-based prism.

Of course, the number of supporting structures may vary and the supporting structures may differ from one another. Furthermore, the arrangement of the supporting structures in the peripheral side area may also differ from that shown in the figures.

Thus, for example, in other embodiments (not illustrated), the supporting structures 10 differ. For example, they are of different widths, such that the free space of the central area 2 defined by the supporting structures 10 takes the shape of a prism whose base is a four sided polygon or quadrilateral, such as a parallelogram.

In other embodiments (not illustrated), the EE bay includes a different number of supporting structures, each supporting structure being placed in a peripheral side space, the number of peripheral side spaces of the peripheral side area also being other than four.

For example, three supporting structures are arranged such that the free space in the central area takes the shape of a triangular prism.

In another example, five supporting structures are arranged such that the free space in the central area takes the shape of a pentagonal prism.

According to one embodiment, a supporting structure 10 includes in particular a front face 11, side faces 12, 14 and a back face 13. The supporting structure 10 further includes a shelf 15 on which electronic equipment 20 is positioned.

The front face 11 is located on the side of the central area 2 of the EE bay 1, and is thus visible to an operator 30 located in the central area 2.

The front face 11 is the portion of the supporting structure 10 allowing electronic equipment 20 to be inserted into the supporting structure 10 and removed therefrom.

Thus, the electronic equipment 20 can be accessed via the central area 2 of the EE bay 1. An operator 30 located in the central area 2 of the EE bay 1 is consequently able to carry out the operations for maintaining the electronic equipment 20 in the EE bay 1. The operator 30 accesses the central area 2 of the EE bay via the opening 5 located in the lower area 4 of the EE bay 1.

It will be noted that, in this embodiment, the central area 2 is in particular defined by the front faces 11 of the supporting structures 10.

The back faces 13 of the supporting structures 10 define the exterior of the EE bay 1.

In one embodiment, the supporting structures 10 are connected to one another such that they form an assembly.

For example, two supporting structures 10 placed side by side are connected to one another by the side faces 12, 14. Thus, attachment means 200 are positioned between side faces 12, 14 of two supporting structures 10 placed side by side in the EE bay 1.

In one embodiment, two attachments 202 (shown schematically in FIG. 1) are located on the side faces 12, 14 next to the front face 11. The attachments 202 allow two supporting structures 10 to be attached by their front faces.

Furthermore, the attachment means 200 include three connecting rods 201a, 201b, 201c (shown schematically in FIG. 1) that are located between the side faces of two supporting structures 10 next to their back faces 13. In this embodiment, a first connecting rod 201a is placed between ends 12aa, 14aa of an upper edge 12a, 14a of the side faces 12, 14. A second connecting rod 201b is placed between ends 12bb, 14bb of a lower edge 12b, 14b of the side faces 12, 14.

By virtue of the first and second connecting rods 201a, 201b, two supporting structures 10 are attached to one another by their back faces 13.

Furthermore, a third connecting rod 201c connects the first connecting rod 201a and the second connecting rod 201b in order to provide the assembly formed by the supporting structures 10 with additional rigidity.

It will be noted that the attachments and the connecting rods are shown schematically since these means are known to a person skilled in the art.

Furthermore, the attachment means may be positioned otherwise and/or may be of another type.

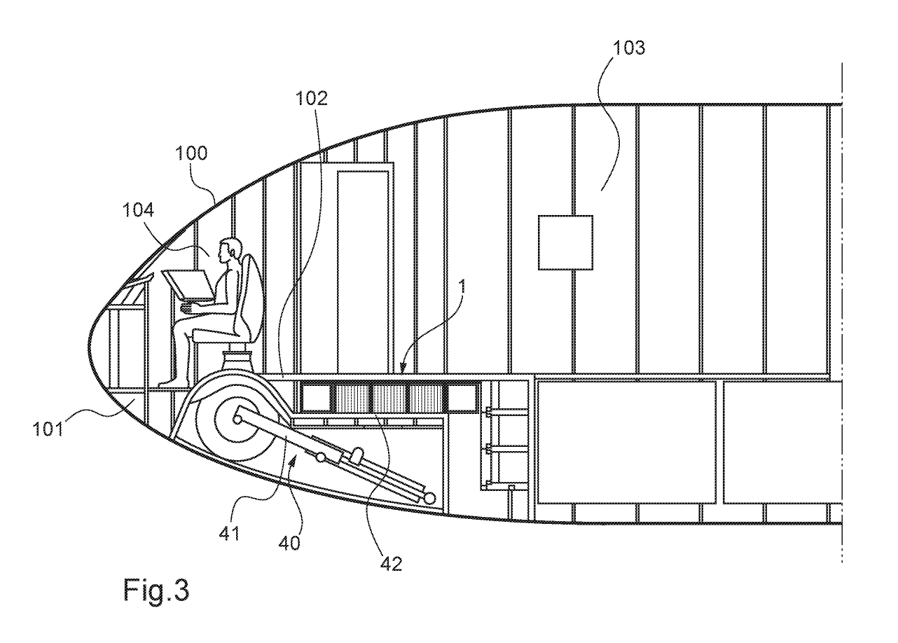

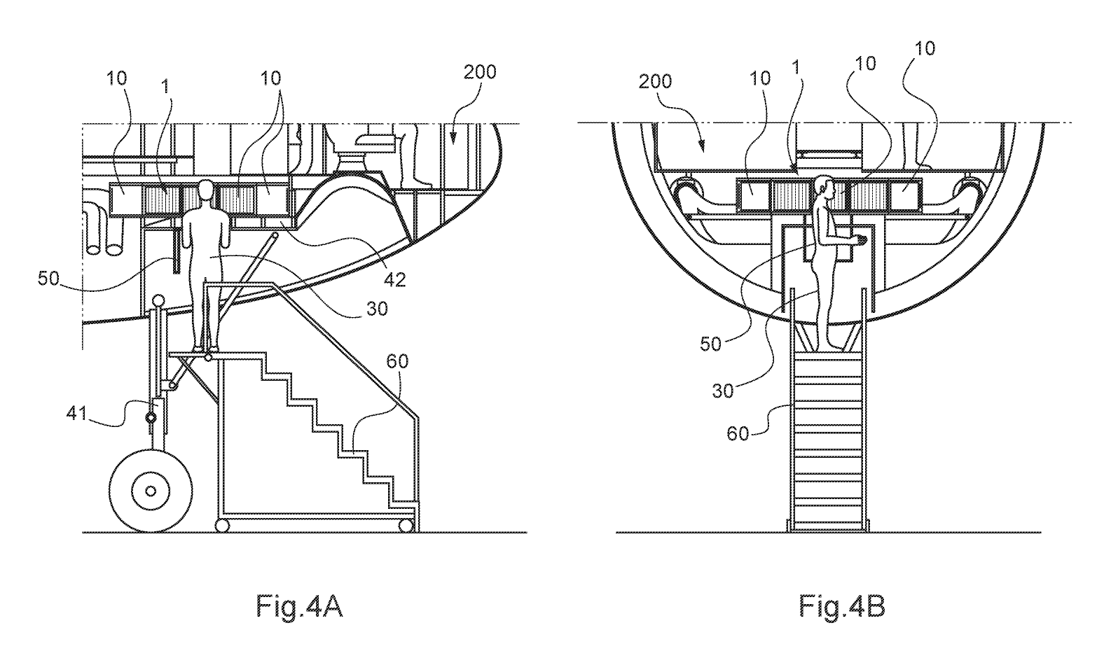

FIGS. 3, 4A and 4B illustrate the positioning of the EE bay 1 according to one embodiment.

With reference to FIG. 3, the EE bay 1 is located in the hold 101 of the aircraft. The hold 101 of the aircraft is the space between the lower portion of the fuselage 100 and the floor 102 of the passenger cabin 103 and of the cockpit of the aircraft 104. In this embodiment, the EE bay 1 is placed in the nose of the fuselage 101.

As may be seen in FIG. 3, the EE bay 1 is placed in a landing gear bay or compartment 40 housing landing gear 41. In particular, the EE bay 1 is placed over a wall 42 forming the ceiling of the landing gear bay 40 or upper wall 42 of the landing gear bay 40.

In one embodiment, the supporting structures 10 are connected by means of attachments 401 to the landing gear bay 40.

For example, the supporting structures 10 are attached to stiffening structures 400 of the landing gear compartment 40.

It will be noted that the attachments 401 connecting the supporting structures 10 and the landing gear compartment 40 are shown schematically since these means are known to a person skilled in the art.

Furthermore, the supporting structures 10 and the landing gear compartment 40 may be attached otherwise.

In this embodiment, the lower area 4 of said EE bay 1 corresponds to the upper wall 42 of the landing gear bay 40 over which the EE bay 1 is positioned. Thus, the EE bay 1 is defined by this upper wall 42 of the landing gear bay 40.

In this embodiment, the EE bay 1 is further defined by the floor 102 of the passenger cabin 103 and the cockpit of the aircraft 104.

In the described embodiment, the access opening 5, allowing access to the EE bay 1, is made in the upper wall 42 of the landing gear bay 40.

In this described embodiment, the EE bay 1 includes an access hatch 50 (FIGS. 4A and 4B) that is located in said upper wall 42 of the landing gear bay 40.

The access hatch 50 is designed to close off the access opening 5. The access hatch 50 may thus assume a closed position (FIG. 3, the access hatch is coincident with the upper wall 42) in which access to the EE bay 1 is closed off, and an open position (FIGS. 4A and 4B) in which an operator 30 is able to access the EE bay 1 in order, for example, to carry out maintenance operations.

In this embodiment, the access hatch 50 opens outward in relation to the EE bay 1.

Unhindered access to the electronic equipment 20 is thus afforded to an operator 30 so that he or she is able to perform maintenance tasks via easy access to the EE bay 1 from outside the aircraft 200, such as shown in FIGS. 4A and 4B.

Of course, in other embodiments, the access hatch 50 may open inward in relation to the EE bay 1. In these embodiments, a person skilled in the art positions the access hatch 50 so that it does not hinder the maintenance of the electronic equipment.

FIGS. 4A and 4B are partial side sectional views of the nose of an aircraft on the ground. FIG. 4A illustrates a longitudinal section and FIG. 4B a cross section.

These figures show the EE bay 1, with the access hatch in the open position, and an operator 30 standing on stairs 60 with a platform, accessing the central area 2 of the EE bay 1 in order, for example, to carry out maintenance operations.

As shown in the figures, the EE bay 1 is easily accessed. Thus, an operator 30 is easily able to access a large number of items of electronic equipment simultaneously, having access thereto via a single access opening 5. Furthermore, maintenance operations may be performed by the operator 30 located stably and in an ergonomic position.

In one embodiment, the access hatch 50 is designed to pressurize the EE bay 1. Thus, the EE bay 1 and the hold 100 of the aircraft 200 are kept pressurized, at standard atmospheric pressure for example.

This type of hatch is known to a person skilled in the art and does not need to be described here.

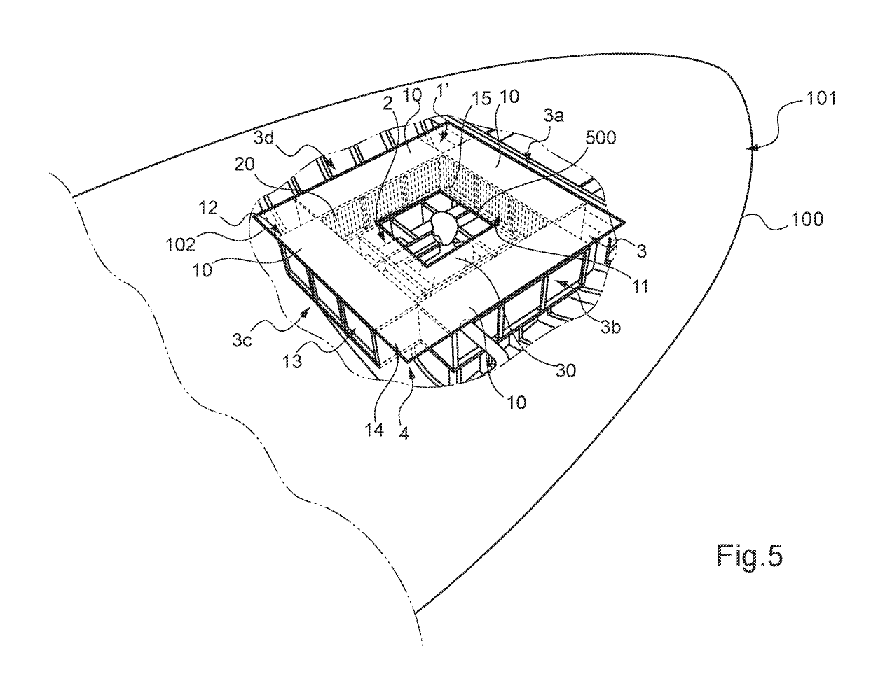

FIG. 5 shows a second embodiment of the EE bay 1′. In this embodiment, the EE bay 1′ includes an additional access opening 500 allowing access to the interior of said electrical and electronic bay 1′.

The additional access opening 500 is placed above the central area 2.

In one embodiment, the additional access opening 500 includes an access hatch (not shown in the figures) made in the floor 102 of the passenger cabin 103 and of the cockpit of the aircraft 104 (shown in FIG. 3).

In one embodiment, the access hatch opens outward in relation to the EE bay 1′. Thus, the access hatch does not hinder access to the electronic equipment.

Of course, in other embodiments, the access hatch may open inward in relation to the EE bay 1′. In these embodiments, a person skilled in the art positions the access hatch so that it does not hinder the maintenance of the electronic equipment.

The arrangement of an additional access opening in the floor 102 of the passenger cabin 103 and of the cockpit of the aircraft 104 allows access to the EE bay 1′ from inside the aircraft. Thus, the electronic equipment may be maintained even though the access opening 5 located at the bottom of the EE bay 1′ is not accessible. For example, maintenance may be carried out while the aircraft is in the air if necessary.

The structure of the EE bay 1′ is similar to that of the embodiment described with reference to FIG. 1. Thus, the EE bay 1′ will not be described here.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An electrical and electronic bay for an aircraft, including at least one supporting structure configured to hold electronic equipment and an access opening allowing access to the interior of said electrical and electronic bay, said electrical and electronic bay comprising:
a central area forming a free space;
a peripheral side area provided for the arrangement of supporting structures and placed around said central area; and
a lower area placed below said central and peripheral side areas, wherein said access opening is placed in said central area.

2. The electrical and electronic bay according to claim 1, wherein said lower area of said electrical and electronic bay corresponds to a wall forming the ceiling of the landing gear bay.

3. The electrical and electronic bay according to claim 2, further comprising an access hatch located in said wall forming the ceiling of said landing gear bay, said access hatch configured to close off said access opening.

4. The electrical and electronic bay according to claim 3, wherein said access hatch is configured to pressurize said electrical and electronic bay.

5. The electrical and electronic bay according to claim 1, further comprising at least one supporting structure placed in said peripheral side area, said at least one supporting structure including a front face located on the side of the central area, the front face allowing electronic equipment to be inserted into the supporting structure and removed from the supporting structure.

6. The electrical and electronic bay according to claim 5, further comprising a plurality of supporting structures arranged in said peripheral side area such that the front faces define said free space of said central area.

7. The electrical and electronic bay according to claim 1, further comprising an additional access opening allowing access to the interior of said electrical and electronic bay), said additional opening being placed above said central area.

8. An aircraft comprising at least at least one electrical and electronic bay according to claim 1.

9. The aircraft according to claim 8, wherein said electrical and electronic bay is placed above a landing gear bay.
